(19) United States
(12) Patent Application Publication
(10) Pub. No.: US 2017/0348711 A1
(43) Pub. Date: Dec. 7, 2017

(54) System and Method for Acrylic Coating

(71) Applicant: Gregory Cole, Garland, TX (US)

(72) Inventor: Gregory Cole, Garland, TX (US)

(21) Appl. No.: 15/240,896

(22) Filed: Aug. 18, 2016

Related U.S. Application Data
(60) Provisional application No. 62/344,655, filed on Jun. 2, 2016.

(51) Int. Cl. B05B 7/08; B05D 3/10; B05D 1/02; B05D 7/26; C09D 133/08; B05D 7/00

(52) U.S. Cl. CPC B05B 7/08; C09D 133/08; B05D 7/588; B05D 1/02; B05D 7/26; B05D 3/107; B05D 7/587

(57) ABSTRACT

A system and method for applying a coating to a surface. The coating can include any typical coating, but in some examples includes a styrenated acrylic coating. The coating is first applied. Thereafter, a quick-set formula which includes a brine solution is applied atop the first coating. The quick-set formula sets the first coating. Thereafter, a second coating, or multiple coatings, can be applied atop the first coating. Due to the quick-set formula, the second coating can be applied in less than 15 minutes.

### PRIORITY

The present invention claims priority to Provisional Application No. 62/344,655 filed Jun. 2, 2016, the entirety of which is hereby incorporated by reference.

### BACKGROUND OF THE INVENTION

### Technical Field

The present invention relates to a system and method for coating a surface.

### Description of Related Art

Acrylic coatings are used in many applications. One such application is as a protective coating on the roof. Application of acrylic coatings, however, are typically limited to very specific weather conditions. For example, most acrylic coatings can only be installed when the temperature is 45° F. and rising. Further, the coating cannot take place early in the morning when there could be dew present. Consequently, it is desirable to a have a coating and method which has more flexibility in the application.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a method of coating in one embodiment;

FIG. 2 is a perspective view of a spraying apparatus in one embodiment;

FIG. 3 is a perspective of another spraying apparatus in one embodiment;

FIG. 4 is a perspective view of the nozzles in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

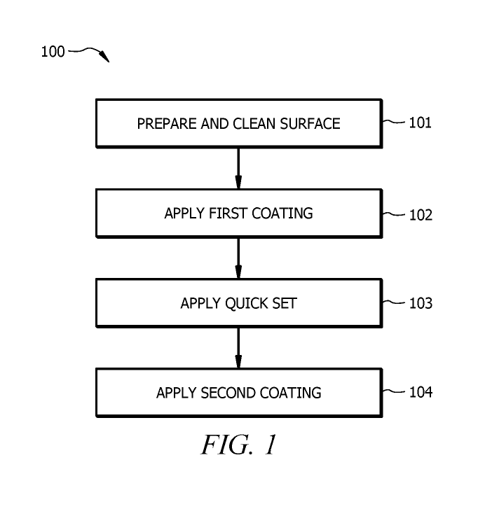

FIG. 1 is a perspective view of a method of coating in one embodiment. One embodiment will be described wherein the coating is applied to a top surface of a roof, but this is for illustrative purposes only and should not be deemed limiting. The roof can comprise any roof, commercial, residential, and industrial. In one embodiment the roof comprises a metal roof. The coating can also be applied to sides of buildings, structures, over other roofing materials and pavements, etc.

In the first step 101 the surface to be coated is prepared and cleaned. The preparation and cleaning step can comprise any methods or equipment known in the art which is currently used to prepare a surface of a structure for coating. As an example, in one embodiment, exposed nuts or bolts are tightened, and any residue is cleaned away. In one embodiment the holes are patched and the seams are reinforced.

The second step 102 is applying a first layer of coating. In one embodiment the coating comprises an acrylic coating. The acrylic coating can comprise any traditional acrylic coating typically used on roofs. As used herein an acrylic coating refers to a liquid-applied seamless membrane used to coat roofs. In one embodiment the coating comprises an elastomeric coating which allows the material to stretch and return to its original shape without damage.

Various types and brands of coatings can be used. These include, but are not limited to acrylic roof coatings. In one embodiment a styrenated acrylic is utilized. Virtually any type of styrenated, and some non-styrenated acrylics, can be used. These include but are not limited to Synthebond by Hexion of Batesville, Ark., Rhoplex 1791 by Dow Chemical.

The thickness of the first coating can vary on the desired application. In one embodiment the thickness ranges from about 10 dry millimeters to about 40 dry millimeters.

The application of the first coat can be accomplished via any method or device known in the art for applying an acrylic coating. These include, but are not limited to, spraying, rolling, mopping, etc. One embodiment utilizing spraying will be used herein, but this is for illustrative purposes only and should not be deemed limiting.

As noted, in one embodiment the first layer of the coating is applied via a sprayer. Virtually any type of sprayer can be utilized. In one embodiment the sprayer has a pressure of between about 100 and 5,000 psi. In one embodiment no air is added during the spraying. In one embodiment the sprayer has a flow rate of approximately ½ to 3 gallons per minutes. In one embodiment the user sprays the coating back and forth to achieve a uniform thickness. After a uniform coating is applied on one portion of the roof, the sprayer is repositioned to spray another portion of the roof.

In the prior art, application of the first coating was limited to stringent and very specific weather conditions. If the weather conditions were not optimal, then the coating could not be applied. In many prior art coating applications, the coating opportunity was limited to when the outdoor temperature was at least 45° F. and rising. Further, the weather had to be dry with no rain before or immediately after application of the coating. These requirements significantly limited the amount of time in which the coating could be applied. The coating could not begin, for example, late in the afternoon when the temperature was decreasing. Rather, the coating had to begin in the morning when the temperature was still rising. Further, the user had to wait for an acceptable weather window where a few days would be rain free before proceeding. Accordingly, scheduling a coating was extremely difficult because a single rain storm can shut down an entire coating application. The result is a very fractured and inefficient application process.

In one embodiment, the method discussed herein can be applied at considerably looser temperature and weather requirements. Thus, for example, in one embodiment, the outdoor temperature during the first coating need not be rising. Further, in one embodiment the method can begin early in the morning even when dew could still be present on the roof. In one embodiment, discussed herein, the first coating combined with the quick-set formula allows the coating to cure quickly. Thus, when it is being spray applied, the application of the coating, followed shortly by the quick-set formula, acts to push away dew and other debris which previous acrylic coatings would have absorbed. Thus, whereas other acrylics could not have been applied early in the morning due to the possible presence of dew, early application of an acrylic coating is now possible.

The problems of the prior art are further exaggerated when a second coat is required. Traditionally, when applying the second coat, the user had to allow the first coat to completely dry and cure. Generally, a user would apply a first coat and then come back the next day to apply the second coat. In one embodiment of the prior art, the coat required about one to 5 days to dry and about 28 days to cure. These times are dependent upon air movement, ambient temperature, thickness, etc. In one embodiment every millimeter of thickness required about 1 hour to cure. This provides increased inefficiencies as the user must bring all the tools and equipment up to the roof, apply the first coating, take down all the tools and equipment, and repeat the process the next day for the second coating. Further, often carrying tools and equipment up and down roofs repeatedly is dangerous. By having to make the same trip multiple times, safety is compromised.

Accordingly, in one embodiment a quick-set formula is applied after the applying the first coating. As used herein a quick-set formula refers to a saline solution which is applied to a layer of acrylic coating which sets the coating. As used herein, setting the coating refers to allowing the coating to cure to a point such that the first coating can be walked upon without the coating attaching to the shoe. The setting time refers to the amount of time required for the coating to set after application of a quick-set formula.

The setting time can vary depending upon a variety of factors, including but not limited to, the composition of the acrylic coating, the humidity, the temperature, and the thickness of the coating. In one embodiment the setting time is less than one hour. In another embodiment the setting time is less than 30 minutes. In another embodiment the setting time is less than 15 minutes. In another embodiment the setting time is less than 5 minutes. The setting time will be dependent upon thickness, ambient temperature, air movement, etc.

As noted, in one embodiment the quick-set formula comprises a saline solution or brine solution. In one embodiment the quick-set formula comprises water and a salt. The salt can comprise virtually any salt, including but not limited to, sodium chloride, calcium chloride, pool salts, rock salt, etc. In one embodiment calcium chloride is used. The calcium-chloride seeks to attract and lift moisture, quickly curing the first coating. As such, the calcium chloride draws and attracts water out of the acrylic resin. Additionally, calcium chloride is not as corrosive as sodium chloride. Further, calcium chloride is not harmful to vegetation. In other embodiments the salt can comprise boric acid, including boric acid mole 12. The quick-set formula can be applied to surfaces such as metal, masonry, wood, single ply membranes, smooth or granule rolled roofing and over various primers.

The amount and concentration of the salt in the quick-set formula can vary depending upon the desired application. In one embodiment the quick-set formula comprises 1-10% by weight salt. In another embodiment the quick-set formula comprises about 4% salt by weight. In one embodiment about 9 pounds of salt are added to 42 pounds of water. In one embodiment the ratio is about 4.6:1, water to salt by weight. In other embodiments about 400 pounds of water are mixed with about 100 pounds of salt. In still another embodiment two 50 pounds bags of salt are added to a 55 gallon drum, and then water is added to fill the drum. The mixture is then stirred.

The quick-set formula can be applied via any method or device used to apply a liquid. These include, but are not limited to, spraying, rolling, painting, spreading, etc. In one embodiment a sprayer is utilized to spray the quick-set formula atop the first layer of coating. The amount of quick-set applied to a coating can vary depending upon the specifications of the acrylic, thickness requirements, etc. In one embodiment 3 gallons of acrylic require 1 pint of quick-set. In one embodiment 55 gallons of acrylic are used for every 5 gallons of quick-set. Thus, in one embodiment the ratio of acrylic to quickset is about 11:1. In one embodiment the quick-set formula is sprayed at a rate of 1 to about 1.5 gallons per 100 square feet per pass. In some embodiments multiple passes may be required. In other embodiments the ratio of acrylic to quick-set can range from about 4.2:1 to about 20:1.

In one embodiment the quick-set formula causes a polymeric eruption which evacuates water and causes an extreme rapid set of the first coating.

The quick-set formula sets the first layer of coating. After the first layer of coating is set, the first layer of coating can withstand most inclement weather. For example, it is no longer problematic if it begins to rain after the first layer of coating has been quick-set. Previously, it was undesirable to have rain before the first layer had sufficient time, often a day, to properly cure. Now, however, the quick-set formula significantly reduces the setting time. Accordingly, inclement weather is no longer a problem after the setting time.

After setting, the user can also walk on the coating. Previously if the user walked upon the first layer of coating immediately after application, the coating would adhere to the user's foot. However, in one embodiment, after application of the quick-set formula, the user can walk upon the first layer of coating without coating adhering to the user's foot and without disturbing the first coat.

Further, after the first layer of coating has been set, then the user can then begin applying the second coating. As stated above, previously the user typically had to wait until the next day to begin applying the second coating, waiting sufficient time until the first coating cured. Now, however, the second coating can be applied as soon as the setting time has completed. As noted, in one embodiment the second coating can be applied less than 15 minutes after the first coating. In other embodiments, the second coating can be applied less than 1 hour after the first coating had been applied.

Accordingly, after the quick-set formula has been applied and the first coating has been allowed to set, a second layer of coating is applied. The second layer of coating can be applied via any method or device discussed herein. In one embodiment the second layer of coating is applied via the same method as the first layer of coating.

The thickness of the second layer can be dependent upon a variety of factors including the thickness of the first layer, the type of coating, etc. In one embodiment the thickness of the second layer ranges from about 10-40 dry millimeters. While one embodiment has been described using two layers, this is for illustrative purposes only and should not be deemed limiting. In other embodiments less than two and in still other embodiments more than two layers are utilized.

After the second layer is applied, the second layer can either cure naturally over time, or a second application of the quick-set formula can be utilized. The second application of quick-set can be applied via any method or device described herein. The benefits of the quick-set formula previously described in reference to the first coating are likewise applicable to the second application of the quick-set formula to the second coating.

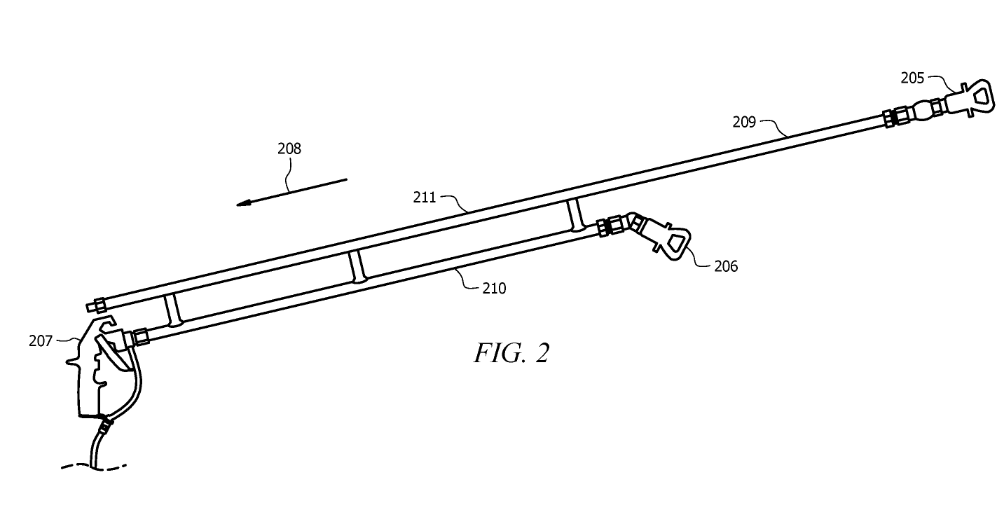

As noted, the acrylic coating and the quick-set formula can be applied via a variety of methods and devices. As noted, in one embodiment the acrylic coating and the quick-set formula can be applied via a sprayer. Because, in some embodiments, the quick-set formula can be applied immediately after the acrylic coating, FIG. 2 depicts a single sprayer which simultaneously applies a coating and the quick-set formula.

As depicted the sprayer 209 comprises a handle 207 which the user will hold and manipulate during application. The sprayer 209 is coupled with a coating source and a quick-set formula source, neither of which is depicted. These sources can comprise a bottle, jug, or other container which houses the quick-set formula and/or the coating source. The system can further comprise a pump which supplies the sprayer 209 the coating and/or the quick-set formula.

In one embodiment the handle 207 comprises a valve which the user can manipulate to control the flow of either the coating, the quick-set formula, or both. In one embodiment the handle comprises two valves such that the flow of both fluids can be controlled. In some embodiments, for example, it may be desirable to stop flow of one of the fluids. As an example, after the coating has been applied it may be desirable to stop the flow of the coating and continue the flow of the quick-set formula.

The sprayer 209 is depicted as having two parallel, and separate, barrels. As depicted, the two separate barrels are coupled via perpendicular support rods which couple the two parallel barrels to one another. This is for illustrative purposes only and should not be deemed limiting. For example, in other embodiments a single outer barrel is used which comprises two separate compartments through which the two separate fluids can flow.

As depicted the handle 207 is coupled to the first barrel 210 which is coupled to the first nozzle 206. In other embodiments, however, the handle 207 is coupled to the second barrel 211.

In the embodiment depicted the user will grasp the sprayer 209 and walk backwards in the direction indicated 208. The coating is applied via the first upstream nozzle 206 and the quick-set formula is applied via the second downstream nozzle 205. As used herein, upstream and downstream refer to locations relative to a position or process. In referring to the sprayer, an upstream location refers to a location which is comparatively closer to the handle 207 whereas downstream refers to a location comparatively further from the handle 207. The first nozzle 206 is closer to the handle 207 and is thus upstream of the second nozzle 205.

The second nozzle 205 is coupled to a second barrel 211 whereas the first nozzle 206 is coupled to a first barrel 210. As depicted the second barrel 211 has a greater length than the first barrel 210.

As can be seen, if the user is walking backwards, the upstream portion of the roof, for example, will be first sprayed with the coating. The coating is applied evenly as described above. Thereafter, when the user walks backwards, the second nozzle 205 will then be above the portion of the roof which was previously sprayed with the first nozzle 206. Thus, that portion of the roof will then be sprayed with the quick-set formula from the second nozzle 205. This pattern is continued as the user advances their day across the roof.

In one embodiment the user starts at one end of the roof. The user turns the sprayer into the “on” position to allow spraying to commence. The user adjusts the sprayer such that the first nozzle 206 is above the roof portion which is to be coated with a coating. The user moves back and forth in the left and right direction to coat the portion of the roof. After coating is complete, the user then moves backwards. At this point, the portion of the roof that was previously being coated by the first nozzle 206 is now being sprayed with the second nozzle 205 and the quick-set formula. Simultaneously, a new portion of the roof is getting coated with the first nozzle 206. This process is repeated the length of the roof until the entire roof has received a coating and a spraying of quick-set formula. The entire process can then be repeated to apply a second coating. Thus, the spray gun depicted allows for the simultaneous application of two separate and distinct fluids. A simultaneous application reduces the amount of time to apply the two separate fluids.

While one embodiment has been described wherein the first nozzle 206 sprays a coating and the second nozzle 205 sprays the quick-set formula, this is for illustrative purposes only and should not be deemed limiting. In other embodiments, for example, the first nozzle 206 will spray the quick-set formula and the second nozzle 205 will spray the coating. In such embodiments, the user will walk forwards rather than backwards.

While FIG. 2 depicts an embodiment wherein the length of the barrel 211 for the second nozzle 205 is longer than the length of the barrel 210 for the first nozzle 206, this is for illustrative purposes only and should not be deemed limiting. In other embodiments the barrel for the first and second nozzles are approximately equal.

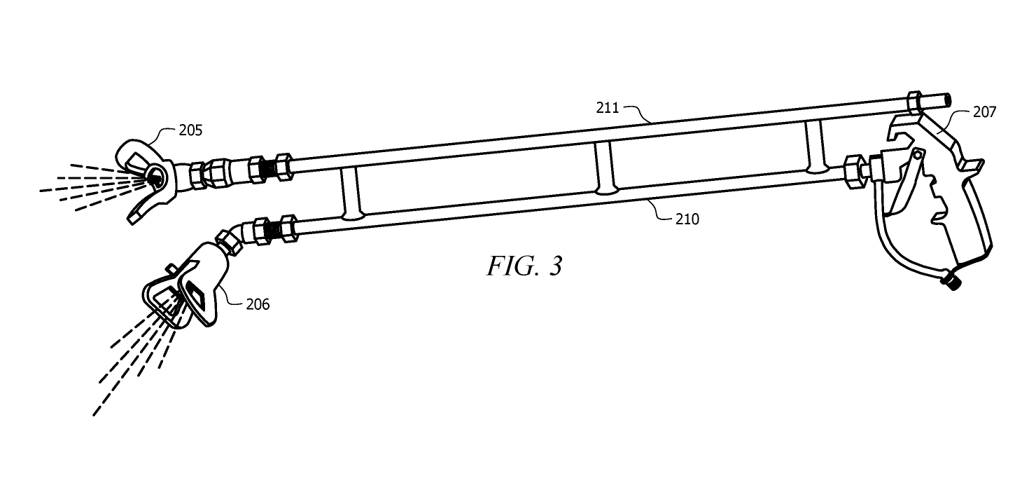

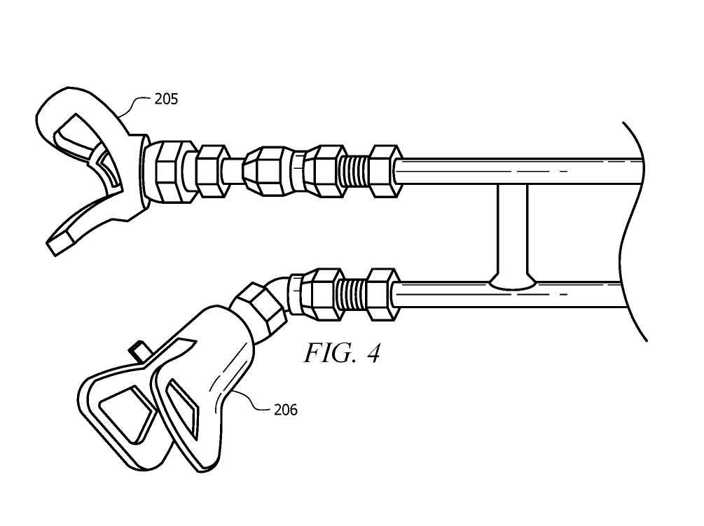

As noted, in FIG. 2, the barrel for the second nozzle 205 is longer because when the user is walking backwards the coating will be applied first followed shortly thereafter by the quick-set. However, in other embodiments the same effect is realized despite the lengths of barrels coupled to the first and second nozzles being approximately equal. FIG. 3 is a perspective of another spraying apparatus in one embodiment wherein the two barrels are approximately equal in length. FIG. 4 is a perspective view of the nozzles in one embodiment.

As shown in FIG. 3, the second barrel 211 and the first barrel 210 are approximately equal in length. Despite the barrel length being approximately equal in length, the orientation of the respective nozzles, in one embodiment, ensures that the coating will be applied first with the quick-set formula being applied atop the coating. In one embodiment the second nozzle 205 is oriented approximately perpendicular to the orientation of the first nozzle 206. In one embodiment the second nozzle 205 is oriented to spray outward in parallel orientation with the direction of the barrel whereas the first nozzle 206 is oriented to spray downward. In this arrangement the coating reaches the surface first with the quick-set reaching the surface thereafter such that it rests upon the coating.

Various nozzles can be used. In one embodiment the quick-set is sprayed as a mist. In one embodiment the nozzle for the quick-set comprises a 517 nozzle, though other sizes can be used. The nozzle for the coating can also range in sizes. In one embodiment the nozzle for the coating ranges from 525-841.

The spray gun having barrels of equal lengths has several benefits. First, is the ability to reach tighter spaces and corners. With barrels of unequal length it is sometimes difficult to place the nozzle with the shorter barrel in the corner. However, with barrels of approximately equal length the spray gun can be placed and directed right into a corner. Second is the increased maneuverability.

While the barrels depicted in FIGS. 2 and 3 are long, this is for illustrative purposes only and should not be deemed limiting. The barrel lengths, as measured form the control to the nozzle can range from 3 inches to 7 feet.

In one embodiment the spray guns comprise a chrome coating. A chrome coating, or other suitable coating, prevents build-up of the material within or on the spray gun. This allows for increased usage without plugging.

The system and method discussed herein has several benefits. First, the quick-set formula increases productivity. As noted, previously users were required to apply the first coating, wait an extended amount of time, and then apply a second coating. This is an inefficient use of time and resources. The quick-set formula allows the user to apply the first coat, apply the quick-set, and then very soon afterward apply the second coating. Thus, the quick-set allows for an efficient use of user's time and resources.

Second, the quick-set formula improves safety and decreases possibilities for accidents. As explained, often when a user or crew has applied a first coat, they must then remove their tools and equipment from the roof. Then, after an extended amount of time, and often the next day, the user or crew must then carry the tools and equipment back up to the roof. Carrying equipment up and down ladders repeatedly can be dangerous. Reducing the number of trips up and down a ladder while carrying heavy equipment is a benefit which results in increased safety.

Third, the quick-set formula allows the user to extend their work day. As noted, previously there were very stringent temperature requirements for applying acrylic coatings. These temperature requirements often eliminates large portions of a day. However, the quick-set allows the coating to cure comparatively much faster which means more work can be accomplished in a single day. Further, because the second coat, if needed, can be applied much more quickly, an entire job can be completed in a single setting.

Fourth, as noted, the prior art methods also required stringent weather conditions before the coatings could be applied. However, the quick-set formula allows the coating to be applied in seasons not previously suitable. Thus, the quick-set formula extends the work season.

Fifth, by being more efficient, the quick-set formula allows the user to save time and money. Consider a contractor employing four employees to coat a roof. Under the prior art the contractor would require the employees to travel to the job site, hoist the required tools and equipment up to the roof, and apply the first coating. The employees would then have to remove the tools and equipment from the roof. The next day, generally, the employees would again have to travel to the job site, again hoist the necessary tools and equipment, and then provide the second coating. Such an exercise is much more costly to the contractor than having the same number of employees complete two coatings in the same day. Duplicative trips to the job site, as well as hoisting and removing tools and equipment multiple times up the roof are eliminated. Thus, a contractor using the quick-set formula saves time and money compared to contractors using the prior art methods.

A sixth benefit is that the system and method allows for the elimination of the need for using reinforcement fabric over ridges, seams, etc. Previously reinforcement fabric was placed on seams and ridges to offer additional support. However, by allowing a structure of layers of coating, the coating can be used in lieu of the costly and time consuming fabric. Thus cost and time are reduced. Multiple coatings such be applied to build a structure.

A seventh benefit is the reduction of the effects of cold wall blistering. This phenomenon results in cracks and blisters in coatings. However, because the coating cures and dries quickly, the blistering effect is minimized or eliminated.

While the invention has been particularly shown and described with reference to a preferred embodiment, it will be understood by those skilled in the art that various changes in form and detail may be made therein without departing from the spirit and scope of the invention.

### ADDITIONAL DESCRIPTION

The following clauses are offered as further description of the disclosed invention.
Clause 1. A method for applying a coating to a surface, said method comprising:
   a. applying a first coating;
   b. applying a quick-set formula atop said first coating, wherein said quick-set formula sets said first coating, and wherein said quick-set formula comprises a brine solution;
   c. applying a second coating atop said first coating.
Clause 2. The method of any proceeding or preceding claim wherein said coating comprises an acrylic coating.
Clause 3. The method of any proceeding or preceding claim wherein said quick-set formula sets said first coating in under 15 minutes.
Clause 4. The method of any proceeding or preceding claim further comprising step d) of applying a quick-set formula after step c).
Clause 5. The method of any proceeding or preceding claim wherein said coating comprises a styrenated acrylic coating.
Clause 6. The method of any proceeding or preceding claim wherein said brine solution comprises calcium chloride.
Clause 7. The method of any proceeding or preceding claim wherein said applying of steps a, b, and c comprise spraying with a single spray gun.
Clause 8. The method of any proceeding or preceding claim wherein said first coating and said quick-set formula are applied at a ratio of between about 3.1:1 and about 20:1.
Clause 9. The method of any proceeding or preceding claim wherein said quick-set formula comprises 1-10% by weight salt.
Clause 10. The method of any proceeding or preceding claim wherein said quick-set formula comprises a ratio of water to salt of between about 4:1 to about 10:1.
Clause 11. The method of any proceeding or preceding claim wherein said applying of step c) occurs within 15 minutes after said applying of step a).
Clause 12. An apparatus for spraying, said apparatus comprising:
   a handle coupled to a first barrel, wherein said first barrel is coupled to a second barrel;
   a first nozzle coupled to said first barrel;
   a second nozzle coupled to said second barrel.
Clause 13. The apparatus of any proceeding or preceding claim wherein said handle comprises a valve, and wherein said first and second barrels are in fluid communication with dissimilar fluids, wherein said second barrel is in fluid communication with a coating source, and wherein said first barrel is in fluid communication with a quick-set formula source.
Clause 14. The apparatus of any proceeding or preceding claim wherein said coating source comprises an acrylic coating, and wherein said quick-set formula comprises a brine solution.
Clause 15. The apparatus of any proceeding or preceding claim wherein said handle comprises a valve, and wherein said first and second barrels are in fluid communication with dissimilar fluids, wherein said first barrel is in fluid communication with a coating source, and wherein said second barrel is in fluid communication with a quick-set formula source.
Clause 16. The apparatus of any proceeding or preceding claim wherein said second nozzle is oriented approximately parallel with said second barrel, and wherein said first nozzle is oriented at an angular relationship to said second nozzle.
Clause 17. The apparatus of any proceeding or preceding claim wherein said first and second barrels are approximately the same length.
Clause 18. The apparatus of any proceeding or preceding claim wherein the second barrel is longer than said first barrel.

We claim:

1. A method for applying a coating to a surface, said method comprising:
a. applying a first coating, wherein said first coating is an acrylic roof coating;
b. applying a quick-set formula atop said first coating, wherein said quick-set formula sets said first coating, and wherein said quick-set formula comprises a brine solution;
c. applying a second coating atop said first coating, and wherein said second coating is an acrylic roof coating.

2. The method of claim 1 wherein said first and second coating are the same coating, and wherein said surface comprises a roof, and wherein said first and second coating comprises a protective roofing coating.

3. The method of claim 1 wherein said quick-set formula sets said first coating in under 15 minutes.

4. The method of claim 1 further comprising step d) of applying a quick-set formula after step c).

5. The method of claim 1 wherein said first and second coating comprise a liquid-applied seamless membrane used to coat roofs.

6. The method of claim 1 wherein said brine solution comprises calcium chloride.

7. The method of claim 1 wherein said applying of steps a, b, and c comprise spraying with a single spray gun.

8. The method of claim 1 wherein said first coating and said quick-set formula are applied at a ratio of between about 3.1:1 and about 20:1 by volume.

9. The method of claim 1 wherein said quick-set formula comprises 1-10% by weight salt.

10. The method of claim 1 wherein said quick-set formula comprises a ratio of water to salt of between about 4:1 to about 10:1 by weight.

11. The method of claim 1 wherein said applying of step c) occurs within 15 minutes after said applying of step a).

12. An apparatus for spraying, said apparatus comprising:
a handle coupled to a first barrel, wherein said first barrel is coupled to a second barrel;
a first nozzle coupled to said first barrel;
a second nozzle coupled to said second barrel.

13. The apparatus of claim 12 wherein said handle comprises a valve, and wherein said first and second barrels are in fluid communication with dissimilar fluids, wherein said second barrel is in fluid communication with a coating source, and wherein said first barrel is in fluid communication with a quick-set formula source.

14. The apparatus of claim 13 wherein said coating source comprises an acrylic coating, and wherein said quick-set formula comprises a brine solution.

15. The apparatus of claim 12 wherein said handle comprises a valve, and wherein said first and second barrels are in fluid communication with dissimilar fluids, wherein said first barrel is in fluid communication with a coating source, and wherein said second barrel is in fluid communication with a quick-set formula source.

16. The apparatus of claim 13 wherein said second nozzle is oriented approximately parallel with said second barrel, and wherein said first nozzle is oriented at an angular relationship to said second nozzle.

17. The apparatus of claim 13 wherein said first and second barrels are approximately the same length.

18. The apparatus of claim 13 wherein the second barrel is longer than said first barrel.

19. The method of claim 1 wherein said first coating comprises a thickness of between 10-40 dry millimeters.
